(19) United States
(12) Patent Application Publication
(10) Pub. No.: US 2015/0348059 A1
(43) Pub. Date: Dec. 3, 2015

(54) SYSTEM AND METHOD FOR DETERMINING THE SHOPPING PHASE OF A SHOPPER

(71) Applicants: Sanjay Agara, Bengaluru (IN); Ajay Mahajan, Bangalore (IN); Aravind Ajad Yarra, Bangalore (IN)

(72) Inventors: Sanjay Agara, Bengaluru (IN); Ajay Mahajan, Bangalore (IN); Aravind Ajad Yarra, Bangalore (IN)

(73) Assignee: WIPRO Limited, Bangalore (IN)

(21) Appl. No.: 14/341,293

(22) Filed: Jul. 25, 2014

(30) Foreign Application Priority Data
May 29, 2014 (IN) 2651/CHE/2014

(51) Int. Cl. G06Q 30/02; G06Q 30/06

(52) U.S. Cl. CPC G06Q 30/0201; G06Q 30/0601

(57) ABSTRACT

The present disclosure relates to methods of systems for analyzing online shopping behavior. Embodiments of the disclosure may receive an event indicating shopping activities of a shopper from a shopping channel and determine an action type associated with the event. A rule engine may classify the event into one of a plurality of shopping phases based on at least one of: classification rules, the action type, or a history of past events. Some embodiments may also calculate a raw score for the shopping phase base on at least one of: an existing number of events in that shopping phase or an event weight associated with the event. In addition, some embodiments may calculate a weighted score based on the raw score and a weighting factor associated with the shopping phase into which the event is classified and determine a target shopping phase based on the weighted score.

### TECHNICAL FIELD

This disclosure relates generally to online e-commerce business. More specifically, it relates to a system and method for determining the shopping behavior of an online shopper.

### BACKGROUND

Many online e-commerce businesses face a challenge of improving conversion rates, i.e., the number of people who made a purchase versus the number of people who just visited the online shopping website. With the current conversion rates in the range of 1% to 5%, businesses struggle to figure out the reasons why shoppers are not making enough purchases on their websites.

Various web analytics tools are available to capture shoppers' clicks as they interact with the digital shopping channels and use click stream analysis to provide a variety of reports that indicate what pages on the website are visited, how many people visited them, page ranking based on traffic, etc. While such information is helpful for the business users to understand how many people visited their website, what products they saw, etc., it does not help them to understand the reasons why shoppers navigated away from the website without a purchase, which is the key to addressing the issue of poor conversion rates.

Business users will therefore be benefited with a higher level of intelligence as compared to mere page view statistics. Insights may be gained by understanding the shopping journey of a shopper. Thus, it is desirable to develop a new online shopping behavior analysis tool that is capable of evaluating the shopping journey of a shopper.

### SUMMARY

Certain embodiments of the present disclosure relate to a method, implemented by a computer, for analyzing online shopping behavior. The method may comprise receiving an event indicating shopping activities of a shopper from a shopping channel and determining an action type associated with the event. A rule engine may classify the event into one of a plurality of shopping phases based on at least one of: classification rules, the action type, or a history of past events. In addition, the method may comprise calculating a raw score for the shopping phase into which the event is classified base on at least one of: an existing number of events in that shopping phase or an event weight associated with the event. Moreover, the method may comprise calculating a weighted score based on the raw score and a weighting factor associated with the shopping phase into which the event is classified and determining a target shopping phase based on the weighted score.

In certain embodiments, the plurality of shopping phases may include two or more of: an Aware phase, a Consider phase, a Learn phase, an Evaluate phase, a Buy phase, an Experience phase, or an Advocate phase.

In certain embodiments, the method may comprise updating a shopper map for the shopper based on the classified event, the shopper map comprising one or more of a shopper ID, a product category ID, the target shopping phase, the raw score and the weighted score associated with each of the plurality of shopping phases, a time of update, a time of entering a particular shopping phase, and a number of action types performed in a particular shopping phase. Updating a shopper map for the shopper may include generating a new shopper map upon determining that the shopper map for the shopper is not present in a context store.

In certain embodiments, the method may comprise retrieving the history of past events from a context store. The history of past events may include a past shopper map based on history information prior to receiving the event.

In certain embodiments, the event may include at least one of: a clickstream event or a device activity event originating from the shopper. The event may comprise an event type and at least one of: a shopper ID, a product category ID, a product ID, and a time stamp.

In certain embodiments, calculating the weighted score may be based on at least one of: a saturation factor indicating a maximum number of events within a shopping phase to be used for calculating the weight score; a decay factor for reducing the weighted score due to a time gap between two events; or a bonus factor for increasing the weighted score due to linear shopping behavior.

In certain embodiments, determining the target shopping phase may comprise selecting a shopping phase having the highest weighted score as the target shopping phase.

In certain embodiments, the classification rules, the weighing factor, and the event weight may be configurable by a business user.

Certain embodiments of the present disclosure also relate to a computer system for analyzing online shopping behavior. The computer system may comprise a processor operatively coupled to a memory device. The processor may be configured to execute instructions stored in the memory device to perform operations. The operations may comprise receiving an event indicating shopping activities of a shopper from a shopping channel and determining an action type associated with the event. A rule engine may classify the event into one of a plurality of shopping phases based on at least one of: classification rules, the action type, or a history of past events. In addition, the operations may comprise calculating a raw score for the shopping phase into which the event is classified base on at least one of: an existing number of events in that shopping phase or an event weight associated with the event. Moreover, the operations may comprise calculating a weighted score based on the raw score and a weighting factor associated with the shopping phase into which the event is classified and determining a target shopping phase based on the weighted score.

Certain embodiments of the present disclosure also relate to a non-transitory, computer-readable medium storing instructions that, when executed by a processor, cause the processor to perform operations comprising receiving an event indicating shopping activities of a shopper from a shopping channel and determining an action type associated with the event. A rule engine may classify the event into one of a plurality of shopping phases based on at least one of: classification rules, the action type, or a history of past events. In addition, the operations may comprise calculating a raw score for the shopping phase into which the event is classified base on at least one of: an existing number of events in that shopping phase or an event weight associated with the event. Moreover, the operations may comprise calculating a weighted score based on the raw score and a weighting factor associated with the shopping phase into which the event is classified and determining a target shopping phase based on the weighted score.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this specification, illustrate several embodiments and, together with the description, serve to explain the disclosed principles.

FIG. 1 illustrates exemplary shopping phases in a shopping journey, according to some embodiments of the present disclosure.

FIG. 2 illustrates an exemplary interaction map between a shopper and a product, according to some embodiments of the present disclosure.

FIG. 3 is a block diagram of an exemplary system for generating a shopper map, according to some embodiments of the present disclosure.

FIG. 4 is a flowchart of an exemplary method for determining a shopper's shopping phase, according to some embodiments of the present disclosure.

FIG. 5A illustrates an exemplary rule table for determining action types, according to some embodiments of the present disclosure.

FIG. 5B illustrates an exemplary rule table for classifying an event into a shopping phase, according to some embodiments of the present disclosure

FIG. 6 shows an exemplary table storing the accumulated raw scores, according to some embodiments of the present disclosure.

FIG. 7 shows an exemplary map containing several shoppers' data, consistent with the some embodiments of the present disclosure.

FIG. 8 illustrates an exemplary table of various factors considered in the calculation of the weighted score, consistent with the present disclosure.

FIG. 9A illustrates an exemplary progress of a shopper's journey, consistent with the present disclosure.

FIG. 9B illustrates another exemplary progress of a shopper's journey, consistent with the present disclosure.

FIG. 10 illustrates an exemplary computer system for implementing methods and systems consistent with the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

In e-commerce business, a shopper's interactions with shopping channels such as online shopping websites can be very valuable to a business because every interaction may reveal certain intent of the shopper. For example, a shopper who has just heard about a product may come to a website and do a cursory scan of the product, such as the functionality of the product, similar products of the same type, the maker and brand of the product, the price point of the product, etc. In another example, a shopper may be farther along in the shopping journey, e.g., who is interested in knowing more about a product, may spend more time on product descriptions, reviews and ratings, product videos, etc.

The present application discloses a system and method for generating a shopper map (also referred to as a Path-To-Purchase (P2P) Shopper Map) by mapping the shopper's interactions with a shopping channel (e.g., mouse clicks, browsing actions, etc.) into a path to purchase journey comprising a plurality of shopping phases.

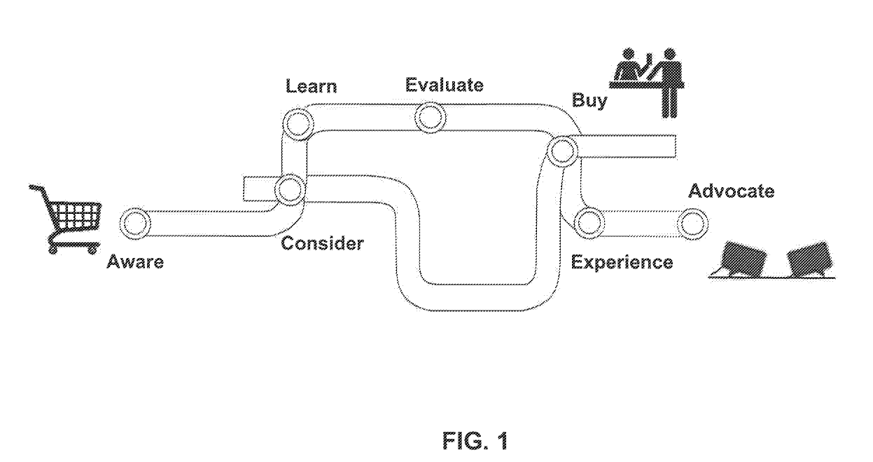

FIG. 1 illustrates exemplary shopping phases in a shopping journey. As shown in FIG. 1, a shopper's path to purchase (and/or beyond) may be divided into a plurality of shopping phases. Examples of the plurality of shopping phase may include an Aware phase, a Consider phase, a Learn phase, an Evaluate phase, a Buy phase, an Experience phase, and an Advocate phase. For example, a shopper may become Aware of a product or a product category based on information sent to him via advertisements directly, through news channels, or from word of mouth and go to a shopping channel (e.g., website, mobile store, etc). Then, the shopper may Consider such product or product category by, for example, trying to assess the need of the product or product category. After that, the shopper may directly go on to buy the product (e.g., impulse purchase), or may decide to Learn more about the product or product category when he becomes interested in the product or product category. For example, the shopper may try to learn about the product and its differentiating attributes by going through the various information sources on the shopping channel. The shopper may then move closer to a purchase decision by Evaluating the product. For example, the shopper may down-select several similar products and may spend more time on reviews, ratings, product comparisons, etc. When the shopper is clear on which product is suitable for his needs, he may proceed to Buy the product. After the shopper finishes the purchase journey, he may gain Experience of the product by, for example, understanding the nuances about the product usage, seeking customer service help, etc. Finally, the shopper may Advocate the product by writing about his product usage experiences on online forums.

In some embodiments, shopping phases may be determined by examining the interactions between a shopper and a shopping channel. The interactions may generate a plurality of Events. For example, events may be sourced from the shopping channel and may be retrieved using Click Stream or equivalent technologies capable of generating such events. Events may be used to evaluate the proper shopping phases a shopper belongs to by a rule engine (also referred to as P2P Shopper Map Engine). In some embodiments, the rule engine may receive or capture various kinds of events without specifying the mechanism of capture. An event may include the following information:

A Shopper ID—the shopper ID may include the ID for a registered user or a cookie ID for an anonymous shopper. The shopper ID may be unique to every shopper and may be used to track a shopper regardless of whether the shopper is a registered user or an anonymous user. When the shopper is an anonymous user, his/her shopper ID may be recognized through cookies or equivalents.

A product category ID and/or a product ID—The product category ID may identify a class or group of products, while the product ID may identify a specific product.

Event date and time—a time stamp indicating when the event occurs.

Event type—the type of the event, including the following exemplary types in no particular order):
1. AddToCart
2. AddToWishList
3. ReviewAndRateProduct
4. RemoveFromCart
5. ResourceCenterAskAQ
6. BrowseResourceCenterForums
7. ReturnProduct
8. ViewCart
9. ViewCategory
10. ViewCategoryFacetedNav
11. ViewChat
12. ViewCheckoutOrderSubmit
13. ViewCheckoutPay
14. ViewCheckoutShip
15. ViewCompareProduct
16. ViewCustomerSvcDeliveryInstallation
17. ViewCustomerSvcReturnsRefunds
18. ViewCustomerSvcServiceProtection
19. ViewDeals
20. ViewFromAdd
21. ViewProductMain
22. ViewProductReviewAndRating
23. ViewProductSpec
24. ViewResourceCenterForums
25. ViewResourceCenterVideos
26. ViewShippingDates
27. ViewStorePickupAvailability
28. ViewSubCategory
29. ViewSubCategoryFacetedNav

In addition to the events, a shopper's Action may also place an important role in evaluation of the shopping phases. An action may indicate a particular interaction between the shopper and the product. It is noted that actions may be different from shopping phases in that the shopping phases can be a series of dynamic processes (e.g., moving from Aware, Consider, Learn, to Evaluate and then Buy), while actions may classify a particular interaction between the shopper and the product. Accordingly, actions may be stored as part of contextual information in a context store, which will be described in greater details below. Actions may include the following types:

Aware—For example, when the shopper becomes aware of a product or a product category by, for example, viewing an advertisement.

View—For example, when the shopper browses a product category or product page, or conducts a search within a product category.

Research—For example, when the shopper investigates the product, e.g., looking at a manual(s), video(s), description and features, reviews and ratings, installation instructions, etc.

Compare—For example, when the shopper compares the product to other products.

Prebuy—For example, actions done before the final buy step, e.g., entering card details, shipping address, etc.

Buy—For example, when the shopper clicks the final purchase button.

Advocate—For example, when the shopper writes about the product in forums.

Review—For example, when the shopper writes a review on the product.

Return—For example, when the shopper initiates a product return.

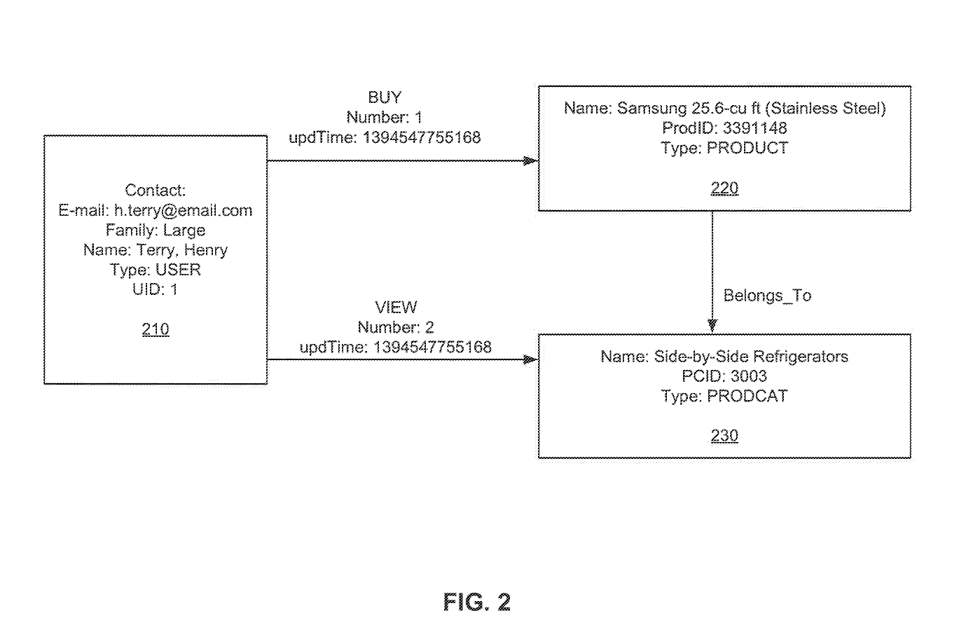

FIG. 2 illustrates an exemplary interaction map between a shopper and a product. In FIG. 2, a registered shopper Henry Terry, whose shopper ID, user type, name, email address, and family size are stored in his user account 210, viewed product category “Side-by-side Refrigerators” (with its product category name, product category ID, and type stored in product category unit 230) two times (e.g., number of VIEW actions is 2), and finally bought a Samsung 25.6 cu ft Stainless Steel refrigerator (with its product name, product ID, and type stored in product unit 220). The latest update times associated with the actions may also be saved (e.g., in updTime field). Product category unit 230 may include a plurality of similar product units. Each product unit, including product unit 220, may belong to product category unit 230.

As the interactions between the shopper and the product are captured, the shopping phase evaluation process may be started to place or classify the shopper into one of the shopping phases in the shopping journey. The shopping phase information can be used in downstream processing. For example, the shopping phase information may be used by a personalization engine to customize the experience for the shopper.

P2P Shopper Map may also help the business to understand where the shoppers are in the entire shopping journey and how they are progressing towards making a purchase. If, for example, there is a drop in the number of shoppers between any two shopping phases, it may reflect that there are some problems at the point/phase at which the drop occurs. This solution may also provide data to business users to further trouble-shoot the potential causes for such drop through analysis of the last event before drop-off, most dominant last event across shoppers, chain of events in the last session, etc.

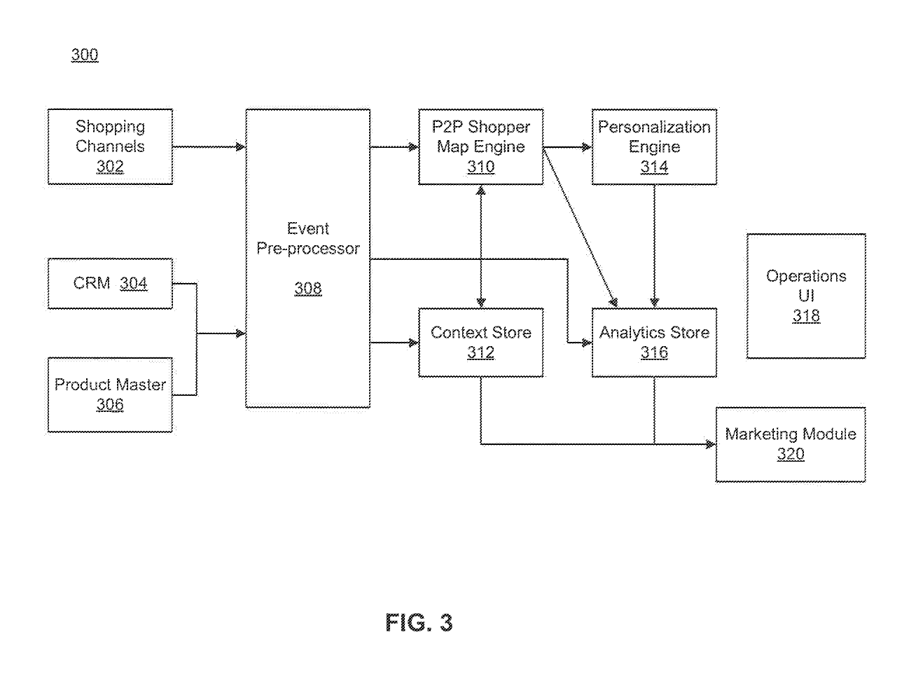

FIG. 3 is a block diagram of an exemplary system 300 for generating a shopper map. As shown in FIG. 3, system 300 may include shopping channels 302. Shopping channels 302 may include online shopping websites, mobile shopping portals (e.g., shopping apps), or other e-shopping interfaces that can be accessed using a computer, a mobile device, etc. In some embodiment, shopping channels 302 may collect shopper interactions and activities in form of click stream events.

System 300 may include a Customer Relationship Manager (CRM) 304. CRM 304 may store and manage shopper information such as identity, demographics information, and any other information available about the shopper.

System 300 may include a product master 306. Product master 306 may store and manage product information and merchandising details, such as category, brand, and other metadata information that the shopper may be interested in.

System 300 may include an event pre-processor 308. Event pre-processor 308 may act as an input gateway that receives all incoming events (e.g., from shopping channels 302, CRM 304, product master 306), validates, enriches the event messages and then sends them to P2P Shopper Map engine 310 and the context store 312. In some embodiments, event pre-processor 308 may act as a bridge between various information (e.g., events from shopping channels 302, shopper's information from CRM 304, product information from product master 306, etc.) and the P2P Shopper Map system (e.g., P2P Shopper Map engine 310, context store 312, analytics store 316, etc.). For example, event pre-processor 308 may receive one or more events from the source of the events in a format determined by the source, and convert the event format into a canonical format (e.g., JSON message) that the P2P system can understand. Event pre-processor 308 may also convert the mechanism from various inputs (REST, HTTP) to a message that can be sent in a messaging system. In addition, event pre-processor 308 may validate if one or more fields (e.g., shopper ID, event type, time stamp, etc.) are present and populated, and if the event type is one of the recognized type. Moreover, event pre-processor 308 may perform enrichment of the information such as adding few details which may be required by the P2P system. For example, event pre-processor 308 may conduct a lookup for a shopper ID based on a cookie ID or a session ID that is provided in the request and/or add the time stamp field if the source doesn't provide that field.

System 300 may include a P2P Shopper Map engine 310. P2P Shopper Map engine 310 may be configured to determine the shopping phase of the shopper. In some embodiments, P2P Shopper Map engine 310 may analyze events (e.g., received from shopping channels 302) generated as a result of the interactions between the shopper and the product, and may use a rule engine and scoring mechanism that leverages the past history of interactions to determine the current shopping phase in the shopping journey. The shopping phase may be used to take personalization actions or to help derive business insights for operations (e.g., downstream operations).

System 300 may include a context store 312. Context store 312 may build the context of the shopper and his interactions with the product category and/or the product. In some embodiments, context store 312 may store past history of shopper interactions, past shopper map, etc. Once the shopping phases are updated (e.g., shopping phase changes as determined by P2P Shopper Map engine 310), the updated shopping phase (e.g., the current shopping phase of the shopper) may be saved into context store 312.

System 300 may include a personalization engine 314. Personalization engine 314 may send personalized messages to the shopper based on shopping phase changes.

System 300 may include an analytics store 316. Analytics store 316 may capture shopping phase changes for further analysis such as aggregation by demographics, date, etc. In some embodiments, analytics store 316 may store the result of the shopper map, all raw events, P2P decisions, and actions, and may create aggregations based on the data. For example, analytics store 316 may provide information about the number of people currently (e.g., near real time) in a given shopping phase, a given product category or product, and a given location. Analytics store 316 may provide phase change history, e.g., at what time did a particular shopper move from one shopping phase to another shopping phase with respect to a product category or product. Analytics store 316 may also provide the number of shoppers entering a particular shopping phase given a date or a time range.

System 300 may include an operations UI 318. Operations UI 318 may be used to configure the business rules that drive the shopping phase determination and to view reports on the shopping journey.

System 300 may include a marketing module 320. Marketing module 320 may use the results from analytics store 316 and context store 312 to aid marketing activities, such as marketing campaign management.

To generate the P2P Shopper Map, shopper interactions may be captured and processed (e.g., using digital foot-print analysis) in real-time using an algorithm that determines the shopping phase the shopper is in. As the shopper continues to interact with the brand or product, the shopper map may be refreshed or updated continuously (e.g., on a real time basis) to reflect the movement of the shopper through the path to purchase journey.

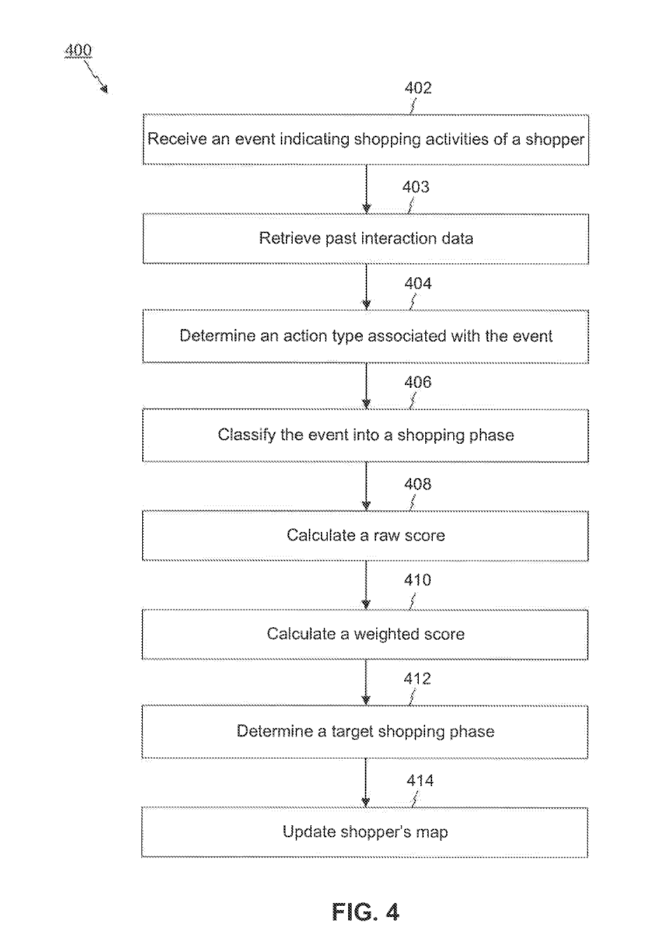

FIG. 4 is a flowchart of an exemplary method 400 for determining a shopper's shopping phase and generating a shopper map. At step 402, P2P Shopper Map engine 310 (also referred to as map engine 310) may receive an event indicating shopping activities of a shopper from shopping channels 302. The event may include click stream data that contain one or more actions done by the shopper, such as viewing a product category page, a product page, reviews, product comparisons, etc. The event may contain a shopper ID, a product category ID or a product ID, event date and time stamp, and the event type.

At step 403, P2P Shopper Map engine 310 may query context store 312 to retrieve past interaction data (e.g., a history of past events, including action types associated with the past events), shopping phase details for a given shopper (e.g., through the shopper ID), and the product the shopper is interested in (e.g., through product ID). In some embodiments, the information obtained from context store 312 may be retrieved in real time or substantially real time. For example, the information may be retrieved from a high performance context store (e.g., a graph database) that uses memory caching techniques.

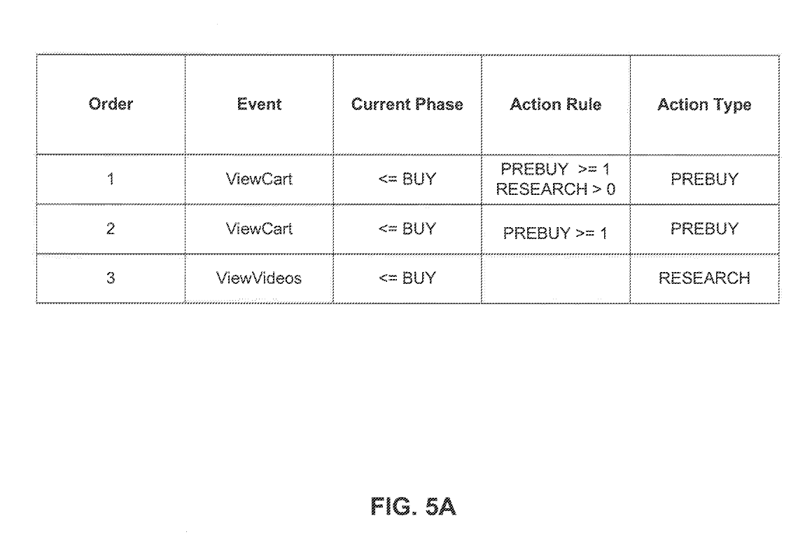

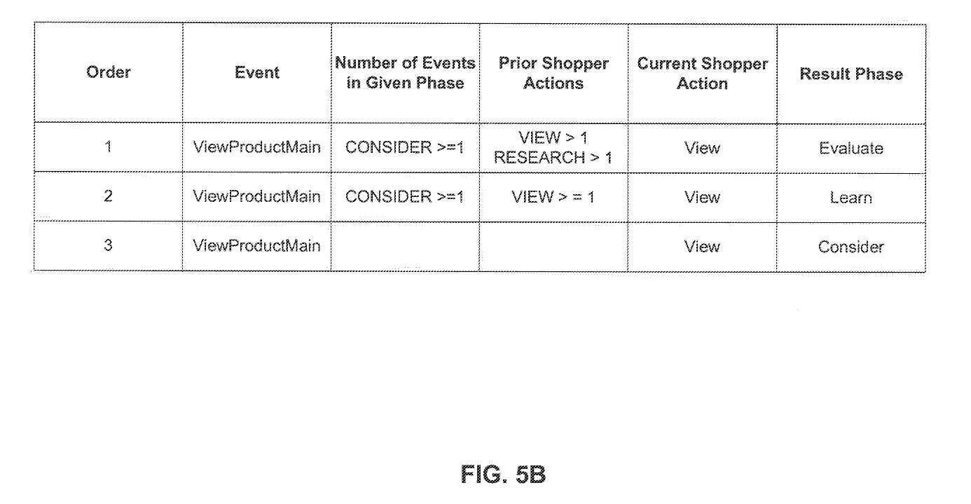

At step 404, a rule engine included in map engine 310 may determine an action type associated with the event. In some embodiments, the action type may be derived through a set of rules (e.g., a rule table). FIG. 5A shows an exemplary rule table to determine an action type associated with an incoming event. In FIG. 5A, column “Order” indicates the order to apply the rules. For example, an incoming event may be compared against the rule set forth in each row of the table, from top to bottom (e.g., in the order from 1 to N as indicated in the “Order” column), one row at a time. Whenever the incoming event matches the rule set forth in a particular row, the determination process may finish and the resulting action type (e.g., in column “Action Type”) set forth in that row may be applied to the incoming event. The “Event” column may include the type of event that is to be compared against the event type of the incoming event. The columns “Current Phase” and “Action Rule” may include additional conditions that must be met by the incoming event in order to be stamped by the action type listed in the same row.

For example, referring to the rule table shown in FIG. 5A. When the rule engine receives an incoming event from shopping channels 302, the rule engine may first apply the rules in the first row to check (1) whether the event is a ViewCart event, (2) whether the current shopping phase is prior to the “Buy” shopping phase (e.g., any one of the Aware, Consider, Learn, Evaluate shopping phases), and (3) whether there has been one or more “Prebuy” actions and at least one “Research” action present in the shopper's history of past events. If all conditions are met, then the rule engine may stop and assign “Prebuy” as the action type to the incoming event. If any one of the condition is not met, then the rule engine may move to the next row in the rule table to check (1) whether the event is a ViewCart event, (2) whether the current shopping phase is prior to the “Buy” shopping phase, and (3) whether the shopper's history of past events contains one or more “Prebuy” actions. If all conditions in the second row are met, then the rule engine may stop and assign “Prebuy” as the action type to the incoming event. If any one of the condition is not met, then the rule engine may move to the next row, in which the rule engine may check (1) whether the event is a ViewVideos event, and (2) whether the current shopping phase is prior to the “Buy” shopping phase. If both conditions in the third row are met, then the rule engine may stop and assign “Research” as the action type to the incoming event. If either condition in the third row is not met, then the rule engine may move to the next row (not shown) to check another set of conditions until reaching a row having all conditions met by the incoming event. It is noted that although the example shown in FIG. 5A applies the same action type “Prebuy” under two different sets of conditions, different rules may be set to generate different action types. In some embodiments, depending on the existing number and type of actions present in a shopper's history of past event, a same type of event received at different timing may yield different action types.

A person skilled in the art would appreciate that other rules and conditions may be designed depending on particular needs of applications. For example, in some embodiments, a simple mapping between the event type and action type may be implemented for simplicity. That is, instead of applying the rule table row by row, the rule engine may simply assign an action type to the incoming event based on the event type. A business user may configure the rules through, for example, operations UI 318.

At step 406, the rule engine may classify the event into a shopping phase based on: classification rules, the action type of the event, and/or the history of past events. The rules engine may evaluate the incoming event received from shopping channels based on past shopping phases and past actions done by the shopper on the product/product category (e.g., fetched from context store 312) and classify the incoming event into a shopping phase. Similar to the rules used for assigning action types shown in FIG. 5A, the rule engine may set forth a set of rules to classify the incoming event into a shopping phase.

FIG. 5B shows an exemplary rule table for classifying the incoming event into a shopping phase. In FIG. 5B, the rule table contains three rows of rules that handle the same ViewProductMain event. The rule engine may apply the conditions set forth in each row to the incoming event, taken into consideration the history of past events and the action type determined at step 404, to determine a result shopping phase into which the incoming event should be classified.

The rule engine may start from the first row (e.g., in accordance with the order set forth in the “Order” column) the go down row by row to check if the conditions in each row are met. Once all the conditions in a particular row are met, the rule engine may stop and assign the shopping phase listed in that row to the incoming event. For example, following the rules in the first row, the rule engine may check if the shopper views (e.g., the action type determined at step 404) the product main page after having done more than one research action and one view action, and the number of events in the Consider shopping phase is at least one (e.g., the shopper is in the Consider shopping phase or higher). If all these conditions are met, then the event may be considered as part of the Evaluate shopping phase.

If not all the conditions listed in the first row are met, the rule engine may move down to the second row to check if the shopper has at least viewed the product before (e.g., View >=1) and the number of events in the Consider shopping phase is at least one (e.g., the shopper is in the Consider shopping phase or higher). If these conditions are met, then the shopper may be considered to be in the Learn shopping phase.

If not all the conditions listed in the second row are met, the rule engine may move down to the third row to check if the shopper arrives without prior history. If so, the rule engine may consider the event as a first time view, and the shopper may be put in the Consider shopping phase.

From the example shown in FIG. 5B, it can be seen that the same event can be construed differently in terms of the result shopping phase based on the circumstances and the past history.

The rule engine may also decide the level of interaction between the shopper and the product based on incoming events, and stamp proper action types to the events and send to context store 312. In FIG. 5B, the action type of all three ViewProductMain events is the same View type. This action type may be determined separately from and/or prior to determining the shopping phase. In some embodiments, the action type may be determined together with the shopping phase based on the same set of rule conditions. The actions and associated action types may be stored and aggregated in context store 312 and used during subsequent event evaluations.

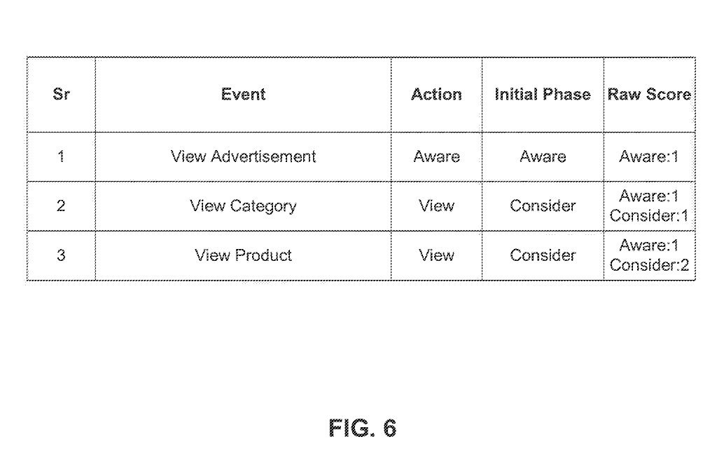

At step 408, a raw score may be calculated for the shopping phase into which the event is classified. Calculation of the raw score may be based on an existing number of events in that shopping phase and/or an event weight associated with the event. In some embodiments, the raw score may be the number of events in a particular shopping phase. Accordingly, the raw score may be calculated by adding the incoming event (e.g., number 1) to the existing number of events in that shopping phase. For example, FIG. 6 shows an exemplary table storing the accumulated raw scores for relevant shopping phase. In FIG. 6, the first row indicates that a shopper views the advertisement of a product, and the event is assigned an action type Aware and classified into the Aware shopping phase. As a result, the raw score for the Aware shopping phase is 1 because it contains only one event. Next, the shopper views the product category. This event is assigned an action type View and classified into the Consider shopping phase. As a result, the raw score for the Consider shopping phase becomes 1 and the raw score for the Aware shopping phase remains 1. Next, the shopper views the product. This event is again assigned an action type View and classified into the Consider shopping phase. As a result, the raw score for the Consider shopping phase becomes 2 and the raw score for the Aware shopping phase remains 1.

In some embodiments, the calculation of raw scores may also take into account event weights. An event weight refers to a weighting factor associated with a particular event. For example, certain event, such as RemoveFromCart, may contribute less to the journey to purchase compared to other events such as ResearchProduct. Therefore, to account for such difference, an event weight may be assigned to each particular event and used as a weighting factor to calculate the raw score. For example, if the event weight associated with ViewProduct is 1 and the event weight associated with RemoveFromCart is 0, then even if the event RemoveFromCart is received from shopping channels 302, the raw score may remain the same.

Calculation of raw score may be an intermediate step. As the number of events in a particular shopping phase increases, the maturity of the shopper in that shopping phase may also increase. To account for the maturity, a saturation factor may be introduced to indicate the maximum number of events within a given shopping phase that are effective in measuring the maturity of the shopper in that shopping phase. In other words, a saturation factor may indicate a number beyond which more events would not contribute towards a change in a weighted score, as will be discussed in greater detail below. For example, in certain embodiment, a saturation factor of 7 can be used. In this embodiment, raw score less than 3 may indicate an early stage, raw scores from 3 to 6 may indicate an increasing maturity, and 7 may indicate the saturation point.

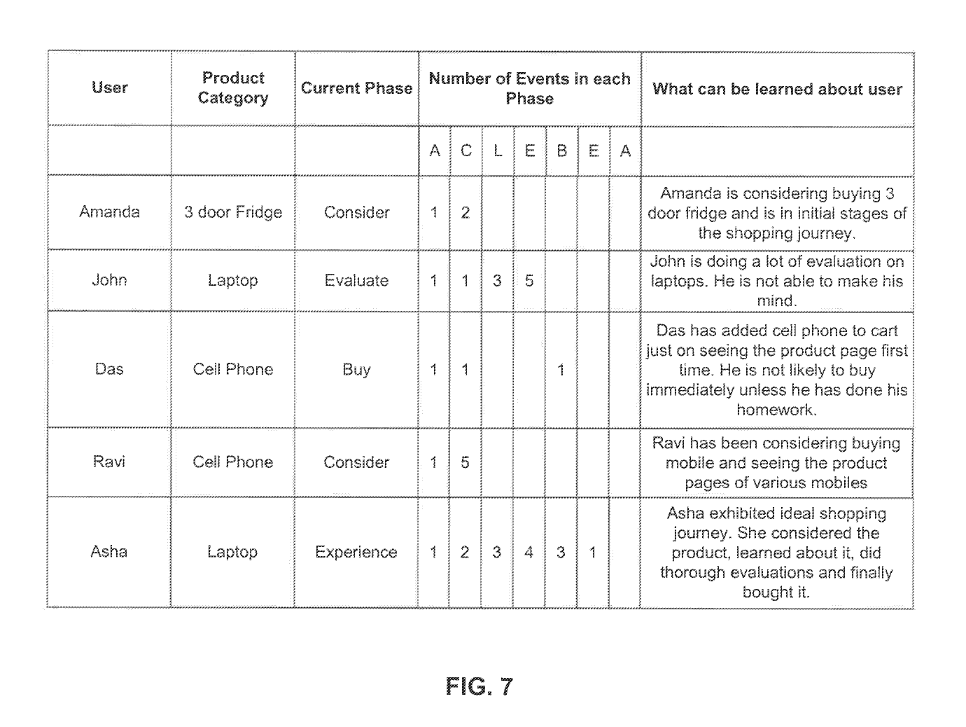

After the raw score for each relevant shopping phase is determined, the shopper map may reveal useful information about the shopping behavior of a shopper. FIG. 7 shows an exemplary map containing several shoppers' data. From the number of events (e.g., raw score) in each shopping phase and the current shopping phase, a business user may learn useful information from each shopper. For example, Amanda is currently in the Consider shopping phase and has only 1 event in the Aware shopping phase and 2 events in the Consider shopping phase. From the information, Amanda may be considering buying a fridge and may be still in the initial stage of the shopping stage. In another example, Asha has gone through each shopping phase step by step and exhibits an idea shopping journey. The case of Das may be considered unusual because he jumps from the Consider shopping phase directly to the Buy shopping phase. Based on this pattern, he may not buy the cell phone immediately unless he has done his homework.

At step 410, a weighted score may be calculated based on the raw score and a weighting factor associated with the shopping phase. The weighted score may be calculated for each shopping phase. The calculation may take into account many factors. For example, the calculation may take into account a phase weight associated with each shopping phase. The phase weight may indicate the comparative relevance of one shopping phase versus another shopping phase. The initial shopping phases may have lower weights as compared to the latter shopping phases. This is because even one event occurring in the latter shopping phases can be more important than a number of events occurring in prior shopping phases.

The calculation may take into account the saturation factor, as described above. The saturation factor may indicate the maximum number of events for each shopping phase beyond which, any further events in that shopping phase will not contribute to the calculation of the weighted score.

The calculation may take into account a decay factor for reducing the weighted score due to a time gap between two events. In some embodiments, the decay factor may be used in the denominator of the calculation. Therefore, the higher the decay factor, the more aging of the shopping phase, which may lead to a reduction in the weighted score. The decay factor may reduce the weighted scores of all shopping phases, except the most recent shopping phase in which event/activity occurs.

The calculation may take into account a bonus factor for increasing the weighted score due to linear shopping behavior, such as the shopping behavior illustrated by Asha in FIG. 7. The bonus factor may also be referred to as no jump bonus, as compared to the jumping behavior illustrated by Das in FIG. 7. If a shopper exhibits a linear journey, with events arriving sequentially in increasing order of shopping phases, there may be a high possibility of purchasing as the shopper has fully investigated the product/service. The bonus factor may increase the weighted score in the Buy shopping phase.

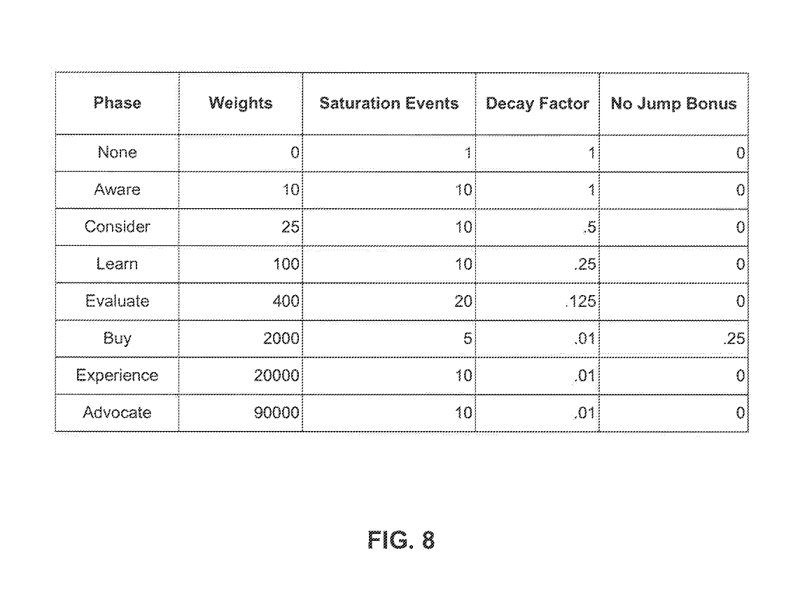

FIG. 8 illustrates an exemplary table of various factors considered in the calculation of the weighted score. Note that the numbers shown in FIG. 8 are for illustration purposes only. A business user may configure these factors based on business needs.

The weighted score may be calculated as follows for all the shopping phases that include at least one event.

A. Raw score (taking into account the saturation factor) in each shopping phase may be multiplied by its associated phase weight.

B. The time duration since the last event in that shopping phase may be used to calculate the decay factor.

C. Linear progress from one shopping phase to another shopping phase may indicate a natural progressive cycle, and may be benefited from the no jump bonus. If a user has jumped a number of shopping phases (e.g., adding to cart after seeing an expensive product the first time), chances of buying that product are likely lower, as compared to someone who researched the product and evaluated it against other products.

D. Update the weighted score for all shopping phases.

The above method may also be expressed mathematically as follows:
Raw score (per phase)=
   Σ[Number of events in that Phase or Saturation factor, whichever is lesser]
Weighted Score (for each Phase)=
   (Raw Score*Phase Wt*(1+no jump bonus))/(1+(decay factor*no of days of inactivity))

Consider the follow example:
1. A shopper clicks on refrigerator advertisement to see a new range of refrigerators at an online website.
2. An event arrives containing—
   a. Event type—ViewAdv
   b. Event date and time—current time stamp
   c. Shopper ID
   d. Product category—refrigerators
3. The event is sent to P2P Shopper Map Engine 310
4. P2P Shopper Map Engine 310 tries to retrieve the past interactions between the shopper and the product category (Refrigerators) from context store 312. However, there is no history.
5. The event and history (e.g., no history) are sent to the rule engine.
6. The rule engine applies rules and stamps the action as Aware and classifies the event into Aware shopping phase.
7. Raw score in Aware shopping phase is calculated to be 1, as there is one event.
8. Weighted score is calculated using the above formula to be (1*10)/1=10 for the Aware shopping phase.

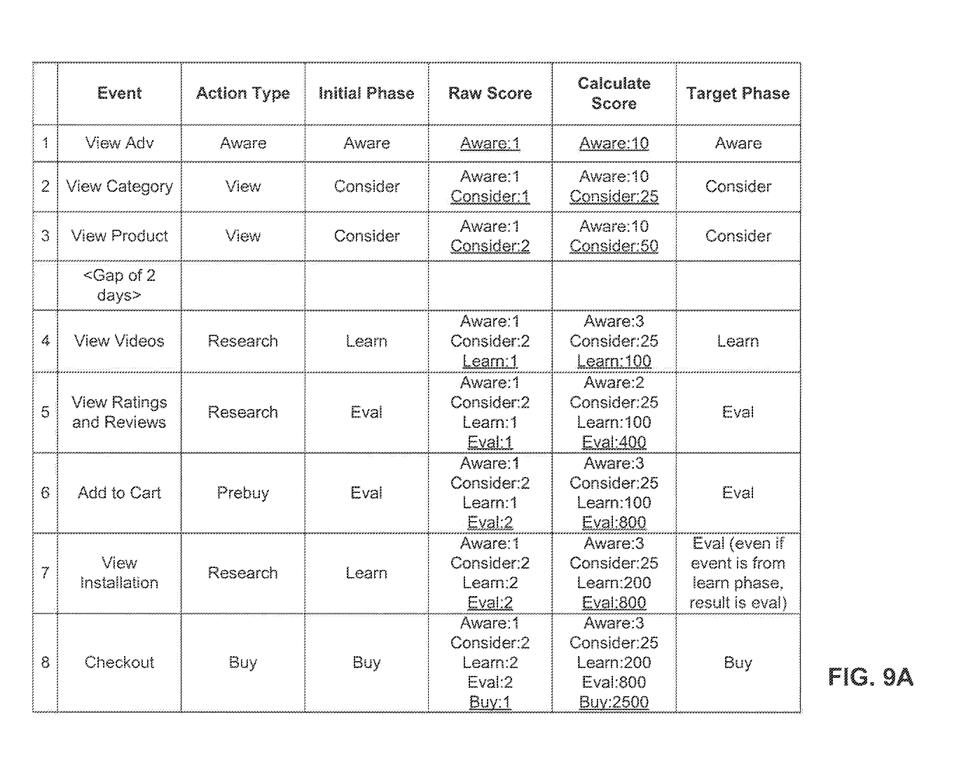

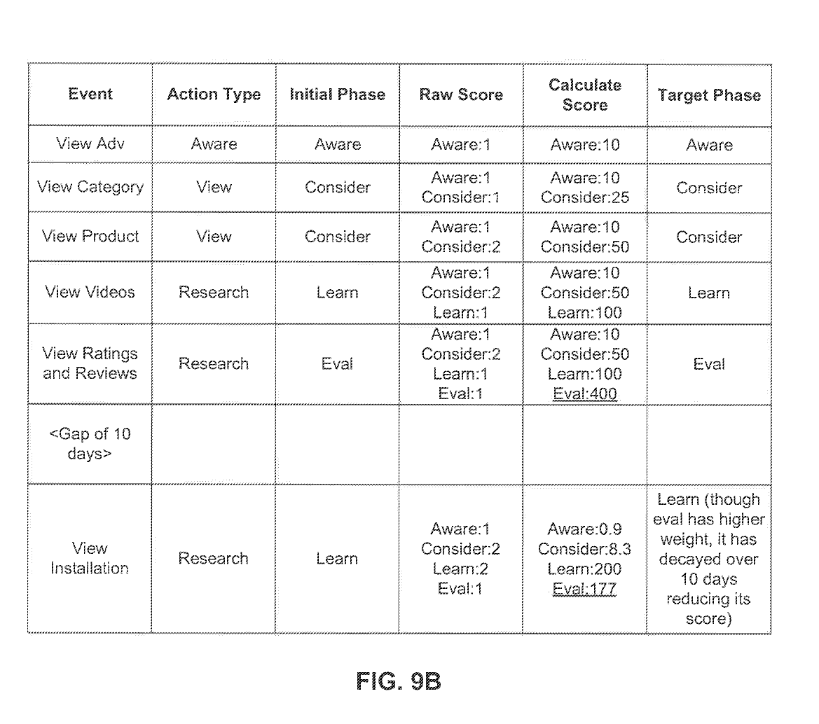

FIG. 9A illustrates the exemplary progress following the above example. Note that in event 7, the weighted score helps to retain the correct target shopping phase (i.e., Evaluation) even though the event is classified into the Learn shopping phase.

FIG. 9B illustrates another exemplary progress in which a large gap is present between the shopper's activities. Note that having a gap of 10 days adds the decay factor into other shopping phases. Because the current event is classified as in the Learn shopping phase, its decay factor is zero, and the weighted score for the Learn shopping phase is unaffected by the decay factor. As a result, the weighted score of the Learn shopping phase is higher than other shopping phases and the target shopping phase is Learn shopping phase.

At step 412, a target shopping phase may be determined based on the weighted score. For example, the shopping phase having the highest weighted score can be selected as the target shopping phase.

At step 414, the shopper map may be updated by adding or updating the target shopping phase to the shopper map. The current weight scores in the shopper map for each of the shopping phases may also be updated. The shopper map may include a shopper ID, a product category ID, the target shopping phase, the raw score and the weighted score associated with each of the plurality of shopping phases, a time of update, a time of entering a particular shopping phase, and a number of action types performed in a particular shopping phase. The updated shopper map may then be stored in context store 312. If the shopper map is not present in context store 312, a new shopper map may be generated. The shopper map may also be broadcast as a message to downstream components for, e.g., reporting and/or personalization.

Systems and methods consistent with the present disclosure may generate the shopper map and analyze behavior of the shopper based on the shopper map. A two-pass correction technique may be employed to ensure that the target phase is correctly identified for the shopper, and the target phase does not accidentally changed by an abnormal activity in previous phases. Business users may configure the weights, saturation, and scoring factors, and may adjust the rules for assigning action types and initial phase, which may be configured at category level. In this way, different shopping journey configurations may be created according to product category. Embodiments of the present disclosure may also identify linear shopping journeys, through which shoppers having high buying potential may be identified.

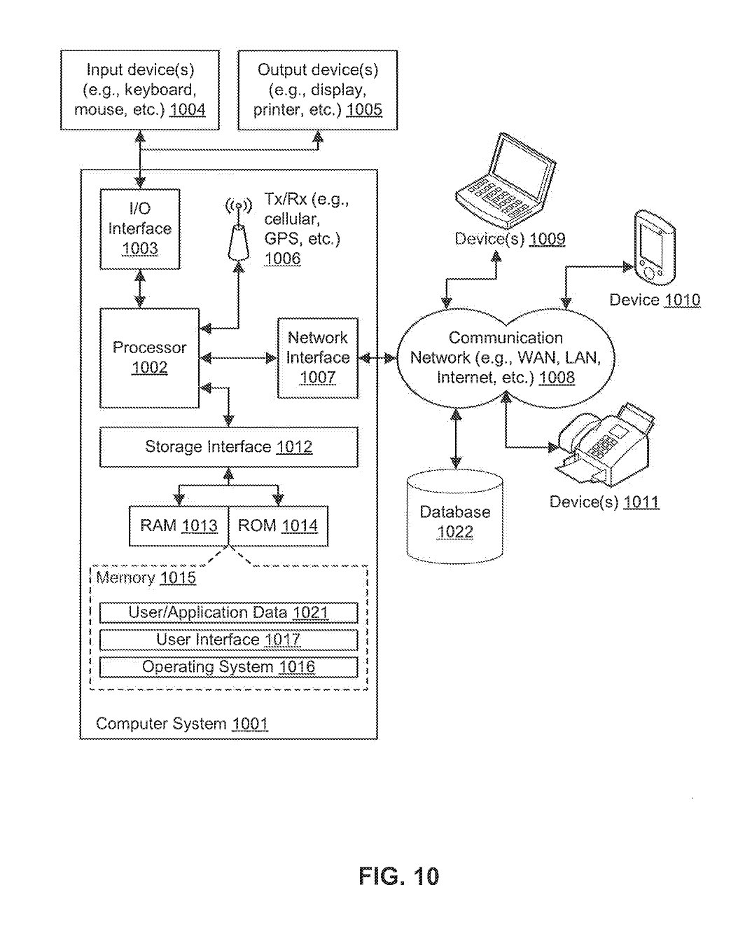

FIG. 10 illustrates an exemplary computer system 1001 for implementing methods and systems consistent with the present disclosure. For example, computer system 1001 may be used to perform the processes as described in FIG. 4. Further, computer system 1001 may be used to perform the function of the modules discussed above.

Computer system 1001 includes processor 1002, which may be a general purpose processor, such as various known commercial CPUs. Processor 1002 may interact with input device(s) 1004 and output device(s) 1005 via I/O interface 1003. A user or administrator may interact with computer system 1001 using input device(s) 1004 such as a keyboard, mouse, card reader, etc. Output device(s) 1005, such as a display or printer, may be used to display or print data reports produced from various process steps. Processor 1002 may also interact with storage interface 1012 to perform part or all of the disclosed method steps. Storage interface 1012 may access to memory 1015, which may include volatile or non-volatile memory capable of storing instructions, as well as any data necessary to facilitate the disclosed method steps. For example, memory 1015 may encompass RAM 1013 or ROM 1014. Memory 1015 may store data such as an operating system 1016, user interface 1017, and user/application data 1021.

Processor 1002 may also interact with communication network 1008 via network interface 1007 to contact remote device(s) 1009, 1010, and/or 1011. Computer system 1001 may also communicate with database 1022 to gather remote or share data to perform any or all of the disclosed method steps. Computer system 1001 may further communicate wirelessly with cellular network, GPS satellites, etc. via transceiver 1006.

The specification has described systems and methods for analyzing online shopping behavior. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method, implemented by a computer, for analyzing online shopping behavior, the method comprising:
receiving an event indicating shopping activities of a shopper from a shopping channel;
determining an action type associated with the event;
classifying, by a rule engine, the event into one of a plurality of shopping phases based on at least one of: classification rules, the action type, or a history of past events;
calculating, by the computer, a raw score for the shopping phase into which the event is classified base on at least one of: an existing number of events in that shopping phase or an event weight associated with the event;
calculating, by the computer, a weighted score based on the raw score and a weighting factor associated with the shopping phase into which the event is classified; and
determining a target shopping phase based on the weighted score.

2. The method of claim 1, wherein the plurality of shopping phases include two or more of: an Aware phase, a Consider phase, a Learn phase, an Evaluate phase, a Buy phase, an Experience phase, or an Advocate phase.

3. The method of claim 1, further comprising:
updating a shopper map for the shopper based on the classified event, the shopper map comprising a shopper ID, a product category ID, the target shopping phase, the raw score and the weighted score associated with each of the plurality of shopping phases, a time of update, a time of entering a particular shopping phase, and a number of action types performed in a particular shopping phase.

4. The method of claim 3, wherein the updating comprises:
generating a new shopper map upon determining that the shopper map for the shopper is not present in a context store.

5. The method of claim 1, further comprising:
retrieving the history of past events from a context store, wherein the history of past events includes a past shopper map based on history information prior to receiving the event.

6. The method of claim 1, wherein
the event includes at least one of: a clickstream event or a device activity event originating from the shopper; and
the event comprises an event type and at least one of: a shopper ID, a product category ID, a product ID, or a time stamp.

7. The method of claim 1, wherein calculating the weighted score is based on at least one of:
a saturation factor indicating a maximum number of events within a shopping phase to be used for calculating the weight score;
a decay factor for reducing the weighted score due to a time gap between two events; or
a bonus factor for increasing the weighted score due to linear shopping behavior.

8. The method of claim 1, wherein determining the target shopping phase comprises:
selecting a shopping phase having the highest weighted score as the target shopping phase.

9. The method of claim 1, wherein the classification rules, the weighing factor, and the event weight are configurable by a business user.

10. A computer system for analyzing online shopping behavior, the system comprising:
a processor operatively coupled to a memory device, wherein the processor is configured to execute instructions stored in the memory device to perform operations comprising:
receiving an event indicating shopping activities of a shopper from a shopping channel;
determining an action type associated with the event;
classifying, by a rule engine, the event into one of a plurality of shopping phases based on at least one of: classification rules, the action type, or a history of past events;
calculating, by the computer, a raw score for the shopping phase into which the event is classified base on at least one of: an existing number of events in that shopping phase or an event weight associated with the event;
calculating, by the computer, a weighted score based on the raw score and a weighting factor associated with the shopping phase into which the event is classified; and
determining a target shopping phase based on the weighted score.

11. The system of claim 10, wherein the plurality of shopping phases include two or more of: an Aware phase, a Consider phase, a Learn phase, an Evaluate phase, a Buy phase, an Experience phase, or Advocate phase.

12. The system of claim 10, wherein the operations further comprise:
updating a shopper map for the shopper based on the classified event, the shopper map comprising a shopper ID, a product category ID, the target shopping phase, the raw score and the weighted score associated with each of the plurality of shopping phases, a time of update, a time of entering a particular shopping phase, and a number of action types performed in a particular shopping phase.

13. The method of claim 12, wherein the updating comprises:
generating a new shopper map upon determining that the shopper map for the shopper is not present in a context store.

14. The system of claim 10, wherein the operations further comprises:
retrieving the history of past events from a context store, wherein the history of past events includes a past shopper map based on history information prior to receiving the event.

15. The system of claim 10, wherein
the event includes at least one of: a clickstream event or a device activity event originating from the shopper; and
the event comprises an event type and at least one of: a shopper ID, a product category ID, a product ID, or a time stamp.

16. The system of claim 10, wherein calculating the weighted score is based on at least one of:
a saturation factor indicating a maximum number of events within a shopping phase to be used for calculating the weight score;
a decay factor for reducing the weighted score due to a time gap between two events; or
a bonus factor for increasing the weighted score due to linear shopping behavior.

17. The system of claim 10, wherein determining the target shopping phase comprises:
selecting a shopping phase having the highest weighted score as the target shopping phase.

18. The system of claim 10, wherein the classification rules, the weighing factor, and the event weight are configurable by a business user.

19. A non-transitory, computer-readable medium storing instructions that, when executed by a processor, cause the processor to perform operations comprising:
receiving an event indicating shopping activities of a shopper from a shopping channel;
determining an action type associated with the event;
classifying, by a rule engine, the event into one of a plurality of shopping phases based on at least one of: classification rules, the action type, or a history of past events;
calculating, by the computer, a raw score for the shopping phase into which the event is classified base on at least one of: an existing number of events in that shopping phase or an event weight associated with the event;
calculating, by the computer, a weighted score based on the raw score and a weighting factor associated with the shopping phase into which the event is classified; and
determining a target shopping phase based on the weighted score.

20. The computer-readable medium of claim 19, wherein the plurality of shopping phases include two or more of: an Aware phase, a Consider phase, a Learn phase, an Evaluate phase, a Buy phase, an Experience phase, or Advocate phase.

21. The computer-readable medium of claim 19, wherein the operations further comprise:
updating a shopper map for the shopper based on the classified event, the shopper map comprising a shopper ID, a product category ID, the target shopping phase, the raw score and the weighted score associated with each of the plurality of shopping phases, a time of update, a time of entering a particular shopping phase, and a number of action types performed in a particular shopping phase.

22. The computer-readable medium of claim 21, wherein the updating comprises:
generating a new shopper map upon determining that the shopper map for the shopper is not present in a context store.

23. The computer-readable medium of claim 19, wherein the operations further comprises:
retrieving the history of past events from a context store, wherein the history of past events includes a past shopper map based on history information prior to receiving the event.

24. The computer-readable medium of claim 19, wherein
the event includes at least one of: a clickstream event or a device activity event originating from the shopper; and
the event comprises an event type and at least one of: a shopper ID, a product category ID, a product ID, or a time stamp.

25. The computer-readable medium of claim 19, wherein calculating the weighted score is based on at least one of:
a saturation factor indicating a maximum number of events within a shopping phase to be used for calculating the weight score;
a decay factor for reducing the weighted score due to a time gap between two events; or
a bonus factor for increasing the weighted score due to linear shopping behavior.

26. The computer-readable medium of claim 19, wherein determining the target shopping phase comprises:
selecting a shopping phase having the highest weighted score as the target shopping phase.

27. The computer-readable medium of claim 19, wherein the classification rules, the weighing factor, and the event weight are configurable by a business user.
